(19) United States
(12) Patent Application Publication
(10) Pub. No.: US 2020/0191556 A1
(43) Pub. Date: Jun. 18, 2020

(54) DISTANCE MESUREMENT METHOD BY AN UNMANNED AERIAL VEHICLE (UAV) AND UAV

(71) Applicant: AUTEL ROBOTICS CO., LTD., Shenzhen, Guangdong (CN)

(72) Inventors: Ning JIA, Shenzhen (CN); Zhihui LEI, Shenzhen (CN)

(73) Assignee: Autel Robotics Co., Ltd., Shenzhen, Guangdong (CN)

(21) Appl. No.: 16/615,082

(22) PCT Filed: Apr. 11, 2018
(86) PCT No.: PCT/CN2018/082653

§ 371 Date: Nov. 19, 2019

(30) Foreign Application Priority Data
May 19, 2017 (CN) 201710356535.6

(51) Int. Cl. G01B 11/02; G01C 5/00; B64C 39/02; H04N 5/225

(52) U.S. Cl. CPC G01B 11/026; G01C 5/00; B64C 2201/123; H04N 5/225; B64C 39/024

(57) ABSTRACT

This application discloses a distance measurement method by an unmanned aerial vehicle (UAV) and a UAV. The distance measurement method by the UAV includes the following steps: obtaining a first image taken by a first imaging apparatus on the UAV at a moment and a second image taken by a second imaging apparatus on the UAV at the moment; determining a first pixel block in the first image and a second pixel block that matches the first pixel block and that is in the second image; where any of the first pixel block and the second pixel block includes at least two pixel points; and determining a distance between the UAV and a target object according to a parallax value of the first pixel block and the second pixel block. As a result, distance measurement efficiency can be improved.

This application is a continuation of International Patent Application No. PCT/CN2018/082653 filed on Apr. 11, 2018, which claims priority to Chinese Patent Application No. 201710356535.6 filed on May 19, 2017, which is incorporated by reference herein in its entirety.

### BACKGROUND

### Technical Field

This application relates to the field of unmanned aerial vehicles, and in particular, to a distance measurement method by an unmanned aerial vehicle (UAV) and a UAV using the method.

### Related Art

With the development of wireless communication technology, wireless local area network, image processing technologies, and battery technologies, an endurance flight function and an image processing capability of an unmanned aerial vehicle (UAV) are becoming increasingly powerful, and increasingly more users are interested in UAV shooting and exploration. When a UAV flies out of the user's field of view, the UAV needs to feed back flight data to a ground control station at a certain frequency, so that the ground control station can control the UAV for obstacle avoidance flight, or the UAV realizes the obstacle avoidance flight according to the obtained flight data. Such a function is necessary to ensure a safe flight of the UAV.

Currently, the UAV may use a vision system to measure a distance from a target object, and the distance is used as the flight data. How to improve measurement efficiency of the vision system on the distance in the UAV has become a topic in an active research by those skilled in the art.

### SUMMARY

In view of this, embodiments of the present invention provide a distance measurement method by an unmanned aerial vehicle (UAV) and a UAV, which can improve efficiency of distance measurement of a vision system.

In a first aspect, an embodiment of the present invention provides a height measurement method by a UAV, including:

obtaining a first image taken by a first imaging apparatus on the UAV at a moment and a second image taken by a second imaging apparatus on the UAV at the moment;

determining a first pixel block in the first image and a second pixel block that matches the first pixel block and that is in the second image; wherein any of the first pixel block and the second pixel block comprises at least two pixel points; and

determining a distance between the UAV and a target object according to a parallax value of the first pixel block and the second pixel block.

Optionally, the determining a first pixel block in the first image and a second pixel block that matches the first pixel block and that is in the second image includes:

determining first block feature information of the first pixel block in the first image;

determining block feature information of each of at least one pixel block in the second image; matching the first block feature information with block feature information of each of the pixel blocks; and

using, as a second pixel block, a pixel block whose block feature information matches the first block feature information and that is in the at least one pixel block.

Optionally, the determining a first pixel block in the first image and a second pixel block that matches the first pixel block and that is in the second image includes:

determining the first pixel block in the first image;

determining at least one pixel block in the second image;

performing pixel matching on the first pixel block and the at least one pixel block; and

determining a second pixel block in the at least one pixel block according to a matching result obtained through the pixel matching.

determining a second pixel block in the at least one pixel block according to a matching result obtained through the pixel matching includes:
using, as a second pixel block, a pixel block having a highest degree of matching a pixel of the first pixel block in the at least one pixel block.

Optionally, the determining a first pixel block in the first image and a second pixel block that matches the first pixel block and that is in the second image includes:

determining a first pixel point in the first pixel block in the first image;

determining at least one pixel block in the second image;

matching the first pixel point with a pixel point comprised in each of the at least one pixel block; and

using, as a second pixel block, a pixel block that includes a pixel point matching the first pixel point and that is in the at least one pixel block.

Optionally, the matching the first pixel point with a pixel point comprised in each of the at least one pixel block includes:

determining point feature information of the first pixel point;

determining point feature information of the pixel point comprised in each of the pixel blocks; and

matching the point feature information of the first pixel point with point feature information of the pixel point comprised in each of the pixel blocks.

Optionally, the first pixel point includes a central pixel point of the first pixel block.

Optionally, the method further includes:

determining first location information of the first pixel block and second location information of the second pixel block; and

determining a parallax value of the first pixel block and the second pixel block according to the first location information and the second location information.

Optionally, the determining first location information of the first pixel block and second location information of the second pixel block includes:

determining first location information of a second pixel point in the first pixel block and second location information of a third pixel point in the second pixel block, the second pixel point matching the third pixel point.

Optionally, the determining a distance between the UAV and a target object according to a parallax value of the first pixel block and the second pixel block includes:

determining a distance between the UAV and a target object according to installation parameters of the first imaging apparatus and the second imaging apparatus and a parallax value of the first pixel block and the second pixel block.

Optionally, the installation parameters of the first imaging apparatus and the second imaging apparatus include at least one of the following:

a spacing between an optical center of a lens of the first imaging apparatus and an optical center of a lens of the second imaging apparatus, a distance from the optical center of the first imaging apparatus to a UAV body, and a distance from the optical center of the second imaging apparatus to the UAV body.

Optionally, if the first image includes at least two first pixel blocks, the determining a distance between the UAV and a target object according to a parallax value of the first pixel block and the second pixel block includes:

determining at least two parallax values;

determining at least two distance values according to the at least two parallax values; and

determining the distance between the UAV and a target object according to the at least two distance values.

Optionally, the determining the distance between the UAV and a target object according to the at least two distance values includes:

calculating an average value of the at least two distance values, and using the average value as the distance between the UAV and the target object.

In a second aspect, an embodiment of the present invention provides a UAV, including:

a first imaging apparatus and a second imaging apparatus; and

a processor respectively connected to the first imaging apparatus and the second imaging apparatus; where

the processor is configured to perform any method in the first aspect.

In a third aspect, an embodiment of the present invention further provides a vision system, including:

at least two imaging apparatuses;

at least one processor respectively connected to the at least two imaging apparatuses; and

a memory communicatively connected to the at least one processor; where

the memory stores an instruction executable by the at least one processor, the instruction is executed by the at least one processor after a user completes interaction through the human interaction unit, so that the at least one processor can perform any method in the first aspect.

In a fourth aspect, a non-transitory computer readable storage medium is further provided in an embodiment of this application. The computer readable storage medium stores a computer executable instruction, the computer executable instruction being configured to cause a computer to perform any method in the first aspect.

In a fifth aspect, a computer program product is further provided in an embodiment of this application. The computer program product includes a computer program stored on a non-transitory computer readable storage medium, the computer program including a program instruction that causes a computer to perform any method in the first aspect when the program instruction is executed by the computer.

The beneficial effects of the embodiments of the present invention are: the UAV height measurement method provided in the embodiment and the UAV do not need to be additionally provided with a special height measurement apparatus. A location between the first imaging apparatus and the second imaging apparatus is preset in combination with a UAV real-time image analysis to implement height measurement from the ground. The height measurement method is simplified, the image matching is stable and reliable, the height measurement response is fast, and measurement accuracy within a set height measurement range is five to ten times higher than that of ultrasonic height measurement.

### BRIEF DESCRIPTION OF THE DRAWINGS

FIG. 1 is a schematic diagram of an unmanned aerial vehicle (UAV) according to an embodiment of the present invention;

FIG. 2 is a schematic flowchart of a distance measurement method by a UAV according to an embodiment of the present invention;

FIG. 3 is a schematic diagram of a height measurement method by a UAV according to an embodiment of the present invention;

FIG. 4 is a schematic diagram of a module of a UAV according to an embodiment of the present invention; and

FIG. 5 is a schematic structural diagram of hardware of a vision system in a UAV according to an embodiment of the present invention.

### DETAILED DESCRIPTION

In order to make the objectives, technical solutions, and advantages of the present invention more comprehensible, the technical solutions according to embodiments of the present invention are clearly and completely described in the following with reference to the accompanying drawings. Apparently, the embodiments in the following description are merely some rather than all of the embodiments of the present invention. All other embodiments obtained by a person of ordinary skill in the art based on the embodiments of the present invention without creative efforts shall fall within the protection scope of the present disclosure.

According to a distance measurement method by an unmanned aerial vehicle (UAV) and a UAV that are provided in the embodiments of the present invention, efficiency and accuracy of a vision system of the UAV for distance measurement can be improved.

The following illustrates an application environment provided by an embodiment of this application.

A UAV may include a flight control system (which is referred to as a flight control system) and a vision system. Optionally, the UAV may further include a plurality of systems such as an ultrasound system, an infrared system, a dynamic system, a power supply system, and a data transmission system.

The flight control system is a core control apparatus of the UAV, which may include: a main control module, a signal conditioning and interface module, a data collection module, and a servo drive module.

The flight control system collects flight state data measured by each sensor in real time, receives a control command and data that are transmitted by a ground controller and that are sent via a radio uplink channel, and outputs the control command to an executing mechanism through calculation, to implement control of various flight modes in the UAV control and management and control of a task device. In addition, the state data of the UAV (that is, flight data) and operating state parameters of an engine, an onboard power supply system, and the task device are transmitted to the data transmission system in real time and are sent back to the ground controller via a radio downlink channel.

The flight control system is further configured to: perform high-precision collection of multichannel analog signals, including a gyro signal, a course signal, a steering angle signal, a rotational speed of an engine, a cylinder temperature signal, dynamic and static pressure sensor signals, power supply voltage signals, and the like. An output switch signal, an analog signal, and a PWM pulse signal can be adapted to the control of different executing mechanisms such as a rudder, an aileron servo, an elevator, an air passage, and a damper servo. Communication with an onboard data terminal, a GPS signal, a digital sensor, and a related task device is respectively implemented using a plurality of communication channels.

Software design of the flight control system is divided into two parts, that is, program design of a logic circuit chip and an application design of the flight control system. The logic circuit chip is configured to form a digital logic control circuit to complete decoding and isolation as well as A/D, D/A and so on. The application is used to implement the foregoing functions of the flight control system.

The vision system includes one or more imaging apparatuses, for example, the vision system may include two imaging apparatuses. In this case, the two imaging apparatuses may also become binocular imaging apparatuses. The imaging apparatus includes an optical component and an image acquisition sensor. The optical component is configured to image an object, and the image acquisition sensor is configured to acquire image data using the optical component. Further, the vision system may further include a processor connected to one or more imaging apparatuses, respectively, and one or more processors may be included. The image data collected by the image acquisition sensor may be transmitted to the processor, and the processor processes the image data collected by the image acquisition sensor. For example, the processor may calculate a distance between a target object and the UAV in the image according to images captured by a plurality of imaging apparatuses simultaneously. The processor may further transmit the calculated distance to the flight control system, so that the flight control system controls the flight of the UAV according to the distance, to implement functions such as obstacle avoidance, tracking, hovering, and the like.

The vision system may be installed at one or more locations such as a front end, a rear end, an upper end, and a lower end of the UAV. The installation location of the vision system on the UAV is not limited in the embodiment of this application. When a vision system is installed on the lower end of the UAV, the vision system may be referred to as an overlooking vision system, and the lower vision system may measure a height of the UAV. In this case, the height may be understood as a distance between the UAV and the ground, that is, the ground is used as a target object.

For other systems in the foregoing UAV, reference may be made to the implementation in the current UAV, which is not described herein.

In the embodiment of this application, that the vision system includes two imaging apparatuses is used as an example for description. Currently, the processor in the vision system may obtain images respectively acquired by the two imaging apparatuses at a same moment, that is, the processor may obtain two images, and may perform pixel point matching on the two images, to obtain matching a pixel point pair. The processor may calculate, according to a parallax value between the matched pixel point pairs, a distance that is between the target object and the UAV and that corresponds to the pixel point.

In this way, the vision system obtains the distance through calculating with low efficiency and low accuracy. In addition, a range of the detected target object is relatively small, for example, only the distance of the target object within 10 meters can be calculated.

According to the distance measurement method by the UAV and the UAV provided in the embodiments of this application, measurement efficiency becomes high, accuracy is high, and the measurement range is wide.

It should be noted that, when the distance measurement method provided by the embodiment of this application is applied to a lower vision system for measuring a height, a flight height of the UAV can be measured through a lower forward orientation with direct and most simplified measurement and calculation. The distance measurement method may also be applied to a lower side view direction height measurement occasion of the UAV under the premise that installation angles of the first imaging apparatus and the second imaging apparatus are predicted.

### Embodiment 1

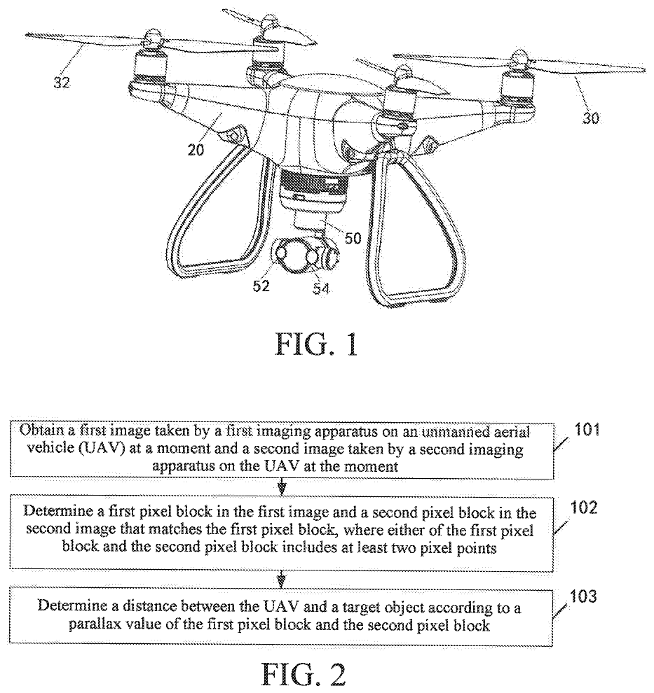

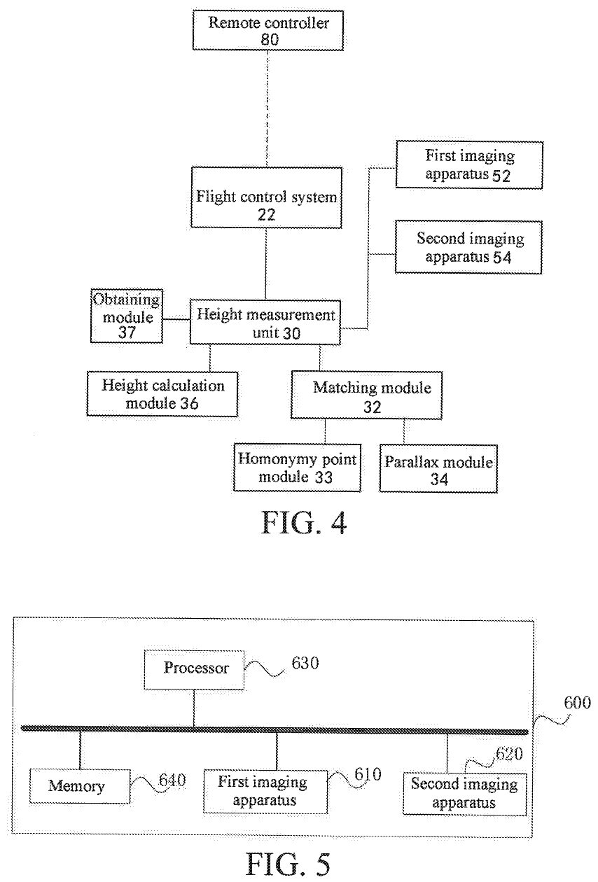

Referring to FIG. 1 and FIG. 4, an unmanned aerial vehicle (UAV) of the present embodiment includes a fuselage 20, a cloud platform 50, propellers 30, 32, and a first imaging apparatus 52 and a second imaging apparatus 54 disposed on the cloud platform. It should be noted that a vision system including the first imaging apparatus 52 and the second imaging apparatus 54 shown in FIG. 1 is installed at a location of a main camera. Definitely, the vision system may further be installed at other locations on the UAV. The location of the vision system and the orientation of the imaging apparatus in FIG. 1 are merely exemplary, which is limited by the embodiments of this application.

The UAV further includes a flight control processor and a wireless communication module connected to the flight control processor. The wireless communication module establishing a wireless connection to a ground remote controller (that is, a ground control station) 80, and the UAV flight state parameters (that is, the foregoing flight parameters) and image data are sent to the ground remote controller 80 via the wireless communication module under the control of the flight control processor. The wireless communication module receives an operation instruction sent by the ground remote controller 80, and the flight control processor completes flight control of the UAV based on the operation instruction. The flight control processor may be a processor in a flight control system.

The vision system may also include a processor, and the processor may be connected to the first imaging apparatus 52 and the second imaging apparatus 54 using a communication interface, a communication bus, or the like. A connection manner between the processor and the imaging apparatus in the vision system is not limited in the embodiment of this application.

At a hardware level:

One or more processors are disposed on the UAV of the embodiment. The one or more processors may be included in the flight control system to control a system hardware module to complete functions such as flight, map transmission, height measurement, and attitude adjustment of the UAV.

In this embodiment, when the first imaging apparatus 52 and the second imaging apparatus 54 are in the lower forward orientation, a more accurate UAV flight height may be measured. When the first imaging apparatus 52 and the second imaging apparatus 54 are not in the lower forward orientation, the processor is also configured to adjust the attitude of the UAV, so that the first imaging apparatus 52 and the second imaging apparatus 54 are in a same height measurement orientation.

In another embodiment, the processor is further configured to obtain an installation angle of the first imaging apparatus 52 and the second imaging apparatus 54 relative to a carrier such as a UAV, respectively. Directions of optical axes of the first imaging apparatus and the second imaging apparatus are adjusted according to the installation angle until the first imaging apparatus 52 and the second imaging apparatus 54 are in a same height measurement orientation.

At a software level:

In addition to flight control hardware such as a battery, a processor, a memory, a wireless communication module, a flight control system 22 and related software of the vision system further need to be carried in the UAV body.

The flight control system 22 is connected to the height measurement unit 30, and the height measurement unit 30 may be understood as a processor in the foregoing vision system. The height measurement unit 30 in the overlooking vision system may be configured to measure a height of the UAV, and the altimeter unit 30 in the vision system at other locations may be configured to measure a distance between the UAV and a target object. The height measurement unit 30 may obtain the first imaging apparatus 52 and the second imaging apparatus 54 on the UAV while simultaneously capturing a first image and a second image in which scenes are partially overlapped. That the scenes in the first image and the second image are partially overlapped may be understood as an overlapping portion of the scene of a same target object on the image when the first image and the second image are superimposed. That is, because the images captured by the two imaging apparatuses have parallax, locations of the same target object in the image are not completely the same, and do not completely overlap, but partially overlap when the locations are superimposed together.

The height measurement unit 30 may control the first imaging apparatus and the second imaging apparatus to simultaneously perform capturing. Alternatively, the first imaging apparatus and the second imaging apparatus may achieve simultaneous shooting according to respective configured crystal oscillators, and the height measurement unit 30 may obtain two images that are simultaneously shot.

The height measurement unit 30 may include a matching module 32, an obtaining module 37, and a height measurement module 36.

The matching module 32 is configured to perform pixel point matching or pixel block matching to obtain a matched pixel point pair or a pixel block pair. The obtaining module 37 is configured to obtain the first image and the second image, and may further be configured to obtain installation parameters of the first imaging apparatus 52 and the second imaging apparatus 54. In this embodiment, the installation parameter is a baseline length, and an imaging focal length f of the imaging apparatus is obtained. The height measurement unit calculates a current accurate flight height of the UAV or a distance between the UAV and the target object according to the installation parameter, that is, one or more parameters of the baseline length, the imaging focal length, and a parallax value between the pixel point pairs or the pixel block pairs.

The UAV further includes an adjusting unit for adjusting the first imaging apparatus and the second imaging apparatus to the height measurement or ranging orientation, that is, correcting the imaging apparatus.

Scene matching is an image analysis and processing technology by which a known image area is determined from another corresponding scene area taken by other sensors a correspondence between scene areas is found. This technology also has important application value in military fields such as navigation and guidance. The scene matching in this application refers to an image analysis and image processing technique for identifying a reference area of an image from a target area between two images through an image comparison matching algorithm and finding an identification homonymy point. In binocular vision, left and right images at a same moment are matched, that is, the left image and the right image are a reference image and a real-time image. A height from the ground is calculated according to the parallax.

In order to achieve scene matching, the matching module 32 includes a homonymy point module 33. The homonymy point refers to two image points formed by a certain point in space on the left and right images. These two image points are the homonymy points, which may also be understood as the matched pixel point pairs. The matching module 32 may further include a pixel block module, the pixel block module being configured to match pixel blocks in the two images to obtain matched pixel block pairs. The matched pixel block may include at least one matched pixel point pair. Alternatively, the pixel block pair may be obtained in other matching manners.

In an implementation, the matching module 33 determines an overlapping area of the first image and the second image, the homonymy point module 33 uses a set area in an overlapping area of the first image as a reference area, pixel matching is performed in the overlapping area of the second image according to the reference area, to obtain a response area having a largest response value. A center point of the response area and a center point of the reference area are homonymy points.

The matching module 33 further includes a parallax module 34. The parallax module 34 determines a coordinate value of the homonymy point in the first image and determines a coordinate value of the homonymy point in the second image, and a difference between the coordinate value of the homonymy point in the first image and the coordinate value of the homonymy point in the second image is the parallax value. Alternatively, the parallax module 34 may determine a parallax value between matched pixel block pairs.

In general, an implementation of scene matching binocular height measurement based on the first image and the second image is: first, the first imaging apparatus 52 and the second imaging apparatus 54 simultaneously capture a group of images, scene matching is performed on the first image and the second image, to obtain an overlapping areas of the two images, and a current location height of a camera may be calculated according to information about the overlapping area, that is, a flying height of the UAV.

When the coordinate value of the homonymy point is calculated, because a result obtained through the scene matching output is the image coordinate value of the homonymy point, the coordinates of the homonymy point may be obtained through directly performing scene matching on the two images formed by the first imaging apparatus 52 and the second imaging apparatus 54.

The adjusting unit of the UAV adjusts the first imaging apparatus and the second imaging apparatus to a height measurement orientation. A principle of the vision system for height measurement is described below with reference to the accompanying drawings.

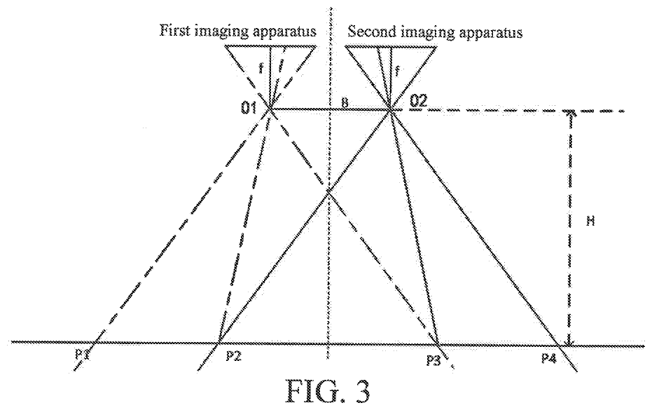

Referring to FIG. 3, in this embodiment, the height measurement orientation is a positive overlooking location, and when the first imaging apparatus 52 and the second imaging apparatus 54 are respectively mounted at an angle of 90 degrees relative to a horizontal plane of the UAV body, the adjusting unit adjusts the first imaging apparatus and the second imaging apparatus to the front overlooking location, so that the optical axis of the first imaging apparatus and the optical axis of the second imaging apparatus are both perpendicular to the ground. In other words, the first imaging apparatus 52 and the second imaging apparatus 54 both take images directly below. That is, the imaging apparatus may be corrected first. The first imaging apparatus 52 and the second imaging apparatus 54 perform shooting directly facing the lower side, a mirror surface of the camera is parallel to the ground, and a line connecting the optical center and the image center is parallel to a vertical line.

From a direct overlooking view, the height may be directly calculated based on the parallax. As shown in FIG. 3, corresponding image points of a ground point P3 in the first image and the second image are O1P3 and O2P3, respectively, and x-direction coordinates are respectively denoted as Xₗ and Xᵣ, and the parallax Δₓ=Xₗ−Xᵣ. Corresponding image points of a homonymy point P3 in the first image and the second image are O1P3 and O2P3, respectively, of which X direction coordinates are respectively denoted as Xₗ and Xᵣ, and the parallax ΔₓXₗ−Xᵣ.

In this case, height measurement of the UAV with the camera from the ground, that is, the flying height of the UAV has the following geometric relationship:

$$H = \frac{fB}{Δ x} ; \qquad ( 1 )$$

where

f is an equivalent focal length, B is a baseline length between two cameras, Δₓ is parallax, that is, displacement of the homonymy point obtained through the scene matching. The equivalent focal length f is a ratio of an actual physical focal length of the camera to a physical size of each pixel, and is an attribute parameter of the camera, which may be obtained through estimation of image attributes of the first image and the second image. It should be noted that the center point herein is only the center point that is located in the reference area and that is obtained through the scene matching, that is, the homonymy point. The displacement herein refers to a difference between x-axis coordinate values of two homonymy point.

The base length of the installation parameters of the present embodiment refers to a distance between optical centers of two imaging apparatuses, which may be obtained by the obtaining module 37 from the flight control system.

During implementation, the adjusting unit of the UAV adjusts the first imaging apparatus 52 and the second imaging apparatus 54 to the height measurement orientation to capture an image for height measurement, and a spacing between an optical center of a lens of the first imaging apparatus and an optical center of a lens of the second imaging apparatus is a preset installation parameter, that is, a baseline length, which may be obtained by the obtaining module 37 from the flight control system. It may be understood that, the installation parameter further includes a distance from the optical center of the first imaging apparatus to a UAV body, and a distance from the optical center of the second imaging apparatus to the UAV body.

In order to further improve measurement accuracy, the first imaging apparatus 52 and the second imaging apparatus 54 use a sub-pixel image sensor that improves coordinate accuracy of the homonymy point. It may be understood that the parallax value is determined using the difference between the pixel coordinate values, and standard image accuracy can only reach 1 pixel at maximum. In the matching algorithm using sub-pixel image precision processing, the coordinate of the homonymy point may be increased to sub-pixels. Sub-pixels can achieve accuracy of 0.1 to 0.3 pixels (pixels), which is at least 3 times higher than that of standard image pixel matching. Therefore, the coordinate precision of the homonymy point may also be increased accordingly, thereby directly improving parallax accuracy. According to formula (1), it may be learned that the parallax Δₓ has a direct influence on the accuracy of solving the height H. Therefore, sub-pixel matching may be used to improve the accuracy of parallax solution, thereby improving accuracy of height solving.

In another embodiment, the height measurement orientation is a side overlooking direction of the first imaging apparatus 52 and the second imaging apparatus 54, and the processor adjusts the UAV attitude to cause the first imaging apparatus and the second imaging apparatus to be at a same height. When installation angles of the first imaging apparatus and the second imaging apparatus respectively relative to the UAV body are not 90 degrees, the adjusting unit adjusts the posture of the UAV, so that the first imaging apparatus and the second imaging apparatus complete shooting respectively when the optical axis is perpendicular to the ground.

When the height measurement orientation is a side overlooking direction, the processor obtains the installation angles of the first imaging apparatus and the second imaging apparatus relative to the UAV, respectively, and adjusts directions of optical axes of the first imaging apparatus and the second imaging apparatus according to the installation angles. When the height measurement orientation is a side overlooking direction, an installation angle is preset between the first imaging apparatus and the second imaging apparatus. From side overlooking view, if the installation angle is known, it may be solved in a similar manner. The angle parameter needs to be obtained in other ways after installation, for example, obtained through calibration in a laboratory environment. The installation angle is known by default in the present invention.

The scene matching UAV height measurement of the embodiment of this application has many technical effects, and only two onboard cameras and an onboard processing chip of the UAV itself are needed with no need to specifically add other UAV height measurement devices. In comparison to the ultrasonic height measurement, there is no need to add ultrasonic devices. With small calculation amount and in a simple and fast manner, an absolute height (height measurement of the UAV from the ground) of the UAV is measured through the binocular scene matching, with measurement accuracy higher 5-10 times than that of the ultrasonic wave.

It may be learned from the visual principle that, when the baseline distance is fixed, and when a distance between the observed object and an observer (the first imaging apparatus and the second imaging apparatus) increases, the parallax also decreases accordingly. Therefore, a height measurement application height of the embodiment of this application is in the range of about 30 meters. When the UAV flies at an altitude of more than 30 m, the flight control system automatically determines a relative height and a ground height using an air pressure UAV height measurement in combination with a GPS UAV height measurement.

### Embodiment 2

Referring to both FIG. 2 and FIG. 4, this application further relates to a distance measurement method by a UAV. The method is implemented based on a computer program run by the height measurement unit 30. The computer program includes a computer program that may be used to implement functions of the height calculation module 36, the matching module 32, the homonymy point module 33, and the parallax module 34.

The distance measurement method by a UAV includes the following steps.

Distance measurement performed by the UAV through the visual system may be triggered when the vision system is enabled, or may be triggered according to a request instruction sent by the ground remote controller 80. Locations of the first imaging apparatus and the second imaging apparatus may be first corrected. An overlooking visual system is used as an example. Angles at which the first imaging apparatus and the second imaging apparatus are respectively installed relative to the carrier are obtained. When the angles at which the first imaging apparatus and the second imaging apparatus are respectively installed relative to the carrier are 90 degrees, locations at which the first imaging apparatus and the second imaging apparatus are photographed are adjusted, so that an optical axis of the first imaging apparatus and an optical axis of the second imaging apparatus are both perpendicular to the ground.

The first imaging apparatus and the second imaging apparatus are adjusted to a height measurement orientation. After the height measurement unit 30 receives an enable instruction, the height measurement unit 30 controls the first imaging apparatus and the second imaging apparatus to be adjusted to the height measurement orientation on the cloud platform. FOR example, the first imaging apparatus and the second imaging apparatus face directly downward.

Step 101: A first image taken by the first imaging apparatus on the UAV at a moment and a second image taken by the second imaging apparatus on the UAV at the moment are obtained.

In an example, the height measurement unit 30 may control the first imaging apparatus and the second imaging apparatus to simultaneously perform photographing, so that the height measurement unit 30 may obtain the first image taken by the first imaging apparatus on the UAV and the second image taken by the second imaging apparatus.

Alternatively, the first imaging apparatus and the second imaging apparatus may perform simultaneous photographing according to a same clock crystal oscillator or clock control unit or according to respective configured synchronized time unit or clock crystal oscillator, to obtain a group of images that are simultaneously taken, that is, the first image taken by the first imaging apparatus and the second image taken by the second imaging apparatus.

The height measurement unit 30 may obtain the group of images that are simultaneously taken for further processing.

Step 102: A first pixel block in the first image and a second pixel block in the second image that matches the first pixel block are obtained, where either of the first pixel block and the second pixel block includes at least two pixel points.

In an example, the first pixel block includes at least two pixel points, and the second pixel block also includes at least two pixel points. The first pixel block may include pixel points of a number the same as or different from that of pixel points included in the second pixel block. The first pixel block and the second pixel block may be understood as the foregoing matched pixel block pair. Alternatively, the first pixel block and the second pixel block may be understood as a partially overlapping scene in two images described in the foregoing embodiment.

The first pixel block in the first image may be matched with the second pixel block in the second image using any of the following methods.

Manner 1: The first pixel block in the first image is determined.

For example, pixels in a specified area in the first image that constitute the first pixel block may be determined, or the first image and the second image are superimposed and aligned to determine an overlapping scene area of the first image and the second image. The overlapping scene area may include an image of the target object. Pixels in an area that constitute the first pixel block in the overlapping scene area are determined. An area of the first pixel block in the first image may be used as a reference area to determine an overlapping area in the second image related to the reference area.

At least one pixel block in the second image is determined.

For example, the second image may be divided into a plurality of pixel blocks, and the pixel blocks may include a same pixel, that is, areas in which the pixel blocks are located overlap. Alternatively, the pixel blocks are independent of each other, that is, do not include a same pixel, the pixel block, the areas in which the pixel blocks are located do not overlap. Alternatively, an area related to a reference area in the second image is determined according to the reference area in which the first pixel block is located, for example, at least one overlapping area. Each overlapping area includes one pixel block, and a pixel block included in one of the overlapping areas is determined as the second pixel block.

First block feature information of the first pixel block and block feature information of each of the at least one pixel block in the second image are determined.

The block feature information herein means an overall feature of the pixel block, which is distinguished from point feature information. The point feature information is used to indicate a feature of a pixel point. The block feature information may represent an overall state, a grayscale, a size, a target object feature, and the like of the pixel block. The block feature information may be represented by a block feature vector, and the block feature information may include a multi-dimensional block feature vector. No limitation is imposed herein.

Compared to matching of the point feature information, the block feature information may be used to more accurately describe features of the target object, thereby improving accuracy of distance calculation.

In particular, the first feature information of the first pixel block is matched with the block feature information of each of the at least one pixel block. Therefore, a second pixel block matching the first pixel block, that is, a pixel block whose block feature information matches that of the first block feature information is obtained from the at least one pixel block as the second pixel block. For example, a pixel block whose block feature vector resembles the first block feature vector at a height degree is determined from the at least one pixel block as the second pixel block.

Manner II: A first pixel block in a first image is determined.

At least one pixel block in a second image is determined.

For the implementation of the foregoing steps, reference may be made to the description in Manner 1.

Pixel matching is performed on the first pixel block and the at least one pixel block.

A second pixel block in the at least one pixel block is determined according to a matching result obtained through the pixel matching.

Specifically, the foregoing pixel matching means that the first pixel block and the pixels in one pixel block of the second image are matched row by row or column by column. Relative locations of each set of pixel points in the pixel block are the same. For example, if a certain pixel point is located in the x^{th} row y^{th} column in the first pixel block, the pixel point that matches the pixel point and that is in the second image is also located in the x^{th} row and y^{th} column in the second pixel block. The set of matched pixel points may be further matched according to point feature information. Point feature information of each pixel point may be represented using a point feature vector. The point feature vector may include a multi-dimensional feature vector, such as a 128-dimensional feature vector, or the like.

After each set of pixel points is matched, a set of matching results may be obtained according to the matching degree of the point feature vectors, for example, the set of pixel points is successfully matched, or the set of pixel points fails to match.

When the first pixel block is matched with all the groups of pixel points in the pixel matching the first pixel block, a matching degree may be determined according to a proportion of matching success in a matching structure, that is, a higher proportion leads to a higher matching degree.

According to the foregoing manner, pixel matching is sequentially performed on the first pixel block and each of the at least one pixel block determined in the second image. Therefore, the second pixel block matching the first pixel block may be determined according to the matching result. For example, a pixel block having a highest matching degree is used as a second pixel block.

Manner 3: A first pixel point in a first pixel block in the first image is determined.

At least one pixel block in a second image is determined.

The first pixel point is matched with a pixel point included in each of the at least one pixel block.

A pixel block that includes a pixel point matching the first pixel point and that is in the at least one pixel block is used as a second pixel block.

Specifically, the first pixel block in the first pixel block is determined, where there may be one or more first pixel points. In other words, in this way, it is not necessary to match all the pixel points in the pixel block, further improving matching efficiency.

The first pixel point may be a center point of the first pixel block, that is, a homonymy point in the foregoing embodiment. Alternatively, the first pixel may further include other pixel points in the first pixel block, which is not limited herein.

Therefore, the first pixel point may be matched with a pixel point of the pixel block in the second image based on the point feature information. A position of the pixel point matched with the first pixel relative to the second image is the same as that of the first pixel relative to the first image.

Further, a second pixel block matching the first pixel block may be determined according to a matching result.

If there is one first pixel point, if a pixel matching the first pixel point exists, a pixel block including the pixel point is the second pixel block.

When there is a plurality of first pixel points, a degree of matching between each pixel block and the first pixel block is determined, thereby determining that a pixel block with a highest degree of matching is the second pixel block.

It should be noted the foregoing steps may be performed in a varied order.

Step 103: A distance between the UAV and a target object is determined according to a parallax value of the first pixel block and the second pixel block.

In an implementation, the parallax value of the first pixel block and the second pixel block may be determined through determining of first position information of the first pixel block and second position information of the second pixel block. In particular, position information of a specific pixel point in the first pixel block and position information of a pixel point in the second pixel block matching the pixel point may be determined to determine the parallax value of the first pixel block and the second pixel block. For example, position information of a central pixel point in the first pixel block and position information of a central pixel point in the second pixel block may be determined.

Certainly, other parameters, such as an angle at which each imaging apparatus is installed, a distance between optical centers of lenses, a distance from an optical center of the first imaging apparatus to the UAV, and a distance between an optical center of the second imaging apparatus to the UAV, etc. may be further obtained, to calculate the distance between the UAV and the target object. No limitation is imposed herein.

Further, if the first image includes at least two first pixel blocks, second pixel blocks respectively matching the at least two first pixel blocks may be obtained in the foregoing manner, so that at least two parallax values may be calculated. In this case, at least two distance values may be determined according to the two parallax values, so that the distance between the UAV and the target object is determined according to the at least two distance values.

In an implementation, an average value of the determined at least two distance values may be calculated, and the average value is used as a value of the distance between the UAV and the target object, that is, distance data calculated by the visual system.

Measurement of a height of the UAV using the foregoing method is described below using an example.

In an embodiment, an accurate current flight height of the UAV is measured.

During determining of a homonymy point, matching the first image with the second image to determine the homonymy point includes:

determining overlapping areas in the first image and the second image, and using a specified area in the overlapping area in the first image as a reference area; and

performing pixel matching in the overlapping area in the second image according to the reference area to obtain a response area with a largest response value, a center point of the response area and a center point of the reference area being the homonymy point.

When there is a plurality of specified areas, an average value of a plurality of height values calculated based on a plurality of homonymy points is used as the height of the UAV.

During determining of the parallax value, a coordinate value of the homonymy point in the first image and a coordinate value of the homonymy point in the second image are determined. A difference between the coordinate value of the homonymy point in the first image and the coordinate value of the homonymy point in the second image is the parallax value.

For the pre-stored installation parameter, that is, the base length, before that the installation parameters of the first imaging apparatus and the second imaging apparatus are obtained, the method further includes: installing the first imaging apparatus and the second imaging apparatus, so that a spacing between the optical center of a lens of the first imaging apparatus and the optical center of a lens of the second imaging apparatus is the preset installation parameter. The installation parameter is stored.

In order to further improve measurement accuracy, a sub-pixel image sensor is used for the first imaging apparatus and the second imaging apparatus to improve coordinate accuracy of the homonymy point.

In another embodiment, a posture of the UAV is adjusted, so that the first imaging apparatus 52 and the second imaging apparatus 54 are in a same height measurement orientation.

The height measurement orientation is a side overlooking direction from the first imaging apparatus and the second imaging apparatus. Angles at which the first imaging apparatus and the second imaging apparatus are respectively installed relative to the carrier are obtained. When the angles at which the first imaging apparatus and the second imaging apparatus are respectively installed relative to the carrier are not 90 degrees, a posture of the carrier is adjusted, so that the first imaging apparatus and the second imaging apparatus respectively take an image when the optical axis is perpendicular to the ground.

Alternatively, angles at which the first imaging apparatus and the second imaging apparatus are respectively installed relative to the carrier are obtained, and directions of the optical axes the first imaging apparatus and the second imaging apparatus are adjusted according to the installation angles. When the height measurement orientation is a side overlooking direction, an installation angle is preset between the first imaging apparatus and the second imaging apparatus.

It can be learned from a visual principle that a larger distance between an object being observed and an observer (the first imaging apparatus and the second imaging apparatus) brings a proportionally decreased displacement that results from parallax. Therefore, a height measurement application height of the embodiment of this application is in the range of about 30 meters. When the UAV flies at an altitude of more than 30 m, the flight control system automatically determines a relative height and a ground height using an air pressure UAV height measurement in combination with a GPS UAV height measurement. Since a technology such as industrial UAV terrain following is used to measure a height from ground, and GPS measurement and barometer measurement are used to measure an absolute height, a corresponding height from ground needs to be subtracted to obtain a current height from ground of the UAV.

In the UAV height measurement method in this embodiment, a height from ground of the UAV is measured using a binocular scene matching image processing technology, and measurement accuracy is 5-10 times higher than that of an ultrasonic wave.

According to the UAV and the UAV height measurement method in this embodiment, other UAV height measurement hardware does not need to be added to the UAV. Only an existing on-board dual camera and an on-board processing chip are required without addition of other devices. Compared to ultrasonic height measurement, no ultrasonic equipment needs to be added. UAV height measurement requires little calculation, and is simple and fast, through which a flying height of the UAV can be fed back in real time, and the height from ground of the UAV can be measured quickly and accurately. The UAV and determining of the homonymy point through image matching and parallax calculation in the UAV height measurement method in this embodiment is stable and reliable, and has low requirements on a scene. Moreover, for the UAV and the UAV height measurement method in this embodiment, a sub-pixel image processing solution may be used, so that the measurement accuracy can be further improved by three times. The UAV and the UAV height measurement method in this embodiment may function in a relatively large distance of a height range of 30 meters.

### Embodiment 3

FIG. 5 is a schematic structural diagram of a visual system according to an embodiment of this application. As shown in FIG. 5, the visual system 600 includes:

at least two imaging apparatuses, where in FIG. 5, two imaging apparatuses: a first imaging apparatus 610 and a second imaging apparatus 620 are used as an example; and

a processor 630 respectively connected to at least two imaging apparatuses.

Certainly, the visual system may further include a memory 640, etc.

The processor 630 may be implemented by at least one visual processing unit (VPU), or may be implemented by other processing units. No limitation is imposed herein.

The processor 630 and the memory 640 may be connected through a bus or in other manners. In FIG. 5, that the processor and the memory are connected through a bus is used as an example. Alternatively, the memory 640 is integrated in the processor 630.

As a non-volatile computer readable storage medium, the memory 640 may be configured to store a non-volatile software program, a non-volatile computer executable program, and a module, for example, a program instruction/module (for example, the height estimation module 36, the matching module 32, the homonymy point module 33, the parallax module 34, etc. shown in FIG. 4). The processor 630 executes various functional applications and data processing of the visual system by executing a non-volatile software program, an instruction, and a module stored in the memory 640, that is, the implements the UAV distance measurement method in the foregoing method embodiment.

The memory 640 may include a program storage area and a data storage area. The program storage area may store any of an operating system and an application required for at least one function, and the data storage area may store distance data, image data, etc. In addition, the memory 640 may include a high speed random access memory, and may further include a non-volatile memory, such as at least one magnetic disk storage device, a flash memory device, or other non-volatile solid state storage devices. In some embodiments, the memory 640 may optionally include memories remotely disposed relative to the processor 630, and the remote memories may be connected to a UAV via a network. An example of the foregoing network includes, but is not limited to, the Internet, an intranet, a local area network, a mobile communications network, and a combination thereof.

The one or more modules are stored in the memory 640. When executed by the one or more processors 630, the one or more modules perform the UAV distance measurement method in any of the foregoing method embodiments, for example, perform step 101 to step 103 in the foregoing method in FIG. 2, and implement functions of the height estimation module 36, the matching module 32, the homonymy point module 33, and the parallax module 34 in FIG. 4.

The foregoing product may perform the method provided in the embodiments of this application and has the corresponding functional modules for performing the method and beneficial effects. For technical details not described in detail in this embodiment, refer to the method provided in this embodiment of this application.

An embodiment of this application provides a non-transitory computer readable storage medium storing computer-executable instructions that are executed by one or more processors, for example, the processor 630 in FIG. 5, so that the one or more processors may perform the UAV distance measurement method in any of the foregoing method embodiments, for example, perform step 101 to step 103 in the foregoing method in FIG. 2, and implement functions of the height estimation module 36, the matching module 32, the homonymy point module 33, and the parallax module 34 in FIG. 4.

The apparatus embodiments described above are merely schematic. The units described as separate parts may be or may not be physically apart. The parts displayed as units may be or may not be physical units, in other words, may be located at a same place, or may be distributed onto a plurality of network units. Some or all modules thereof may be selected based on an actual requirement, to implement an objective of the solution in this embodiment.

Through the description of the foregoing implementations, a person of ordinary skill in the art may clearly understand that the implementations may be implemented by software in addition to a universal hardware platform, or by hardware. A person of ordinary skill in the art may understand that all or some of the processes of the methods in the foregoing embodiments may be implemented by a computer program instructing relevant hardware.

The program may be stored in a computer readable storage medium. During the execution of the program, processes of the foregoing method embodiments may be included. The foregoing storage medium may include a magnetic disc, an optical disc, a read-only memory (ROM), a random access memory (RAM), or the like.

It should be finally noted that the above embodiments are merely intended for describing the technical solutions of the present invention rather than limiting the present invention. Based on the idea of the present invention, the technical features in the foregoing embodiments or different embodiments may be combined, the steps may be implemented in any order, and many other changes in the different aspects of the present invention as described above may exist. For brevity, such changes are not provided in the detailed descriptions. Although the present invention is described in detail with reference to the foregoing embodiments, those of ordinary skill in the art should understand that they can still make modifications to the technical solutions described in the foregoing embodiments or make equivalent substitutions to some technical features thereof, without departing from scope of the technical solutions of the embodiments of the present invention.

What is claimed is:

1. A distance measurement method by an unmanned aerial vehicle (UAV), comprising:
obtaining a first image taken by a first imaging apparatus on the UAV at a moment and a second image taken by a second imaging apparatus on the UAV at the moment;
determining a first pixel block in the first image and a second pixel block that matches the first pixel block and that is in the second image; wherein any of the first pixel block and the second pixel block comprises at least two pixel points; and
determining a distance between the UAV and a target object according to a parallax value of the first pixel block and the second pixel block.

2. The method according to claim 1, the determining a first pixel block in the first image and a second pixel block that is in the second image and that matches the first pixel block comprises:
determining first block feature information of the first pixel block in the first image;
determining block feature information of each of at least one pixel block in the second image; matching the first block feature information with block feature information of each of the pixel blocks; and
using, as a second pixel block, a pixel block whose block feature information matches the first block feature information and that is in the at least one pixel block.

3. The method according to claim 1, the determining a first pixel block in the first image and a second pixel block that is in the second image and that matches the first pixel block comprises:
determining the first pixel block in the first image;
determining at least one pixel block in the second image;
performing pixel matching on the first pixel block and the at least one pixel block; and
determining a second pixel block in the at least one pixel block according to a matching result obtained through the pixel matching.

4. The method according to claim 3, wherein the determining a second pixel block in the at least one pixel block according to a matching result obtained through the pixel matching comprises:
using, as a second pixel block, a pixel block having a highest degree of matching a pixel of the first pixel block in the at least one pixel block.

5. The method according to claim 1, the determining a first pixel block in the first image and a second pixel block that is in the second image and that matches the first pixel block comprises:
determining a first pixel point in the first pixel block in the first image;
determining at least one pixel block in the second image;
matching the first pixel point with a pixel point comprised in each of the at least one pixel block; and
using, as a second pixel block, a pixel block that comprises a pixel point matching the first pixel point and that is in the at least one pixel block.

6. The method according to claim 5, wherein the matching the first pixel point with a pixel point comprised in each of the at least one pixel block comprises:
determining point feature information of the first pixel point;
determining point feature information of the pixel point comprised in each of the pixel blocks; and
matching the point feature information of the first pixel point with point feature information of the pixel point comprised in each of the pixel blocks.

7. The method according to claim 5, wherein the first pixel point comprises a central pixel point of the first pixel block.

8. The method according to claim 1, wherein the method further comprises:
determining first location information of the first pixel block and second location information of the second pixel block; and
determining a parallax value of the first pixel block and the second pixel block according to the first location information and the second location information.

9. The method according to claim 8, wherein the determining first location information of the first pixel block and second location information of the second pixel block comprises:
determining first location information of a second pixel point in the first pixel block and second location information of a third pixel point in the second pixel block, the second pixel point matching the third pixel point.

10. The method according to claim 1, wherein the determining a distance between the UAV and a target object according to a parallax value of the first pixel block and the second pixel block comprises:
determining a distance between the UAV and a target object according to installation parameters of the first imaging apparatus and the second imaging apparatus and a parallax value of the first pixel block and the second pixel block.

11. The method according to claim 10, wherein the installation parameters of the first imaging apparatus and the second imaging apparatus comprise at least one of the following:
a spacing between an optical center of a lens of the first imaging apparatus and an optical center of a lens of the second imaging apparatus, a distance from the optical center of the first imaging apparatus to a UAV body, and a distance from the optical center of the second imaging apparatus to the UAV body.

12. The method according to claim 1, wherein if the first image comprises at least two first pixel blocks, and the determining a distance between the UAV and a target object according to a parallax value of the first pixel block and the second pixel block comprises:
determining at least two parallax values;
determining at least two distance values according to the at least two parallax values; and
determining the distance between the UAV and a target object according to the at least two distance values.

13. The method according to claim 12, wherein the determining a distance between the UAV and a target object according to the at least two distance values comprises:
calculating an average value of the at least two distance values, and using the average value as the distance between the UAV and the target object.

14. An unmanned aerial vehicle (UAV), comprising:
a first imaging apparatus and a second imaging apparatus; and
a processor respectively connected to the first imaging apparatus and the second imaging apparatus; wherein
the processor is configured to:
obtain a first image taken by a first imaging apparatus on the UAV at a moment and a second image taken by a second imaging apparatus on the UAV at the moment;
determine a first pixel block in the first image and a second pixel block that matches the first pixel block and that is in the second image; wherein any of the first pixel block and the second pixel block comprises at least two pixel points; and
determine a distance between the UAV and a target object according to a parallax value of the first pixel block and the second pixel block.

15. The UAV according to claim 14, wherein for the determining a first pixel block in the first image and a second pixel block that matches the first pixel block and that is in the second image, the processor is specifically configured to:
determine first block feature information of the first pixel block in the first image;
determine block feature information of each of at least one pixel block in the second image; match the first block feature information with block feature information of each of the pixel blocks; and
use, as a second pixel block, a pixel block whose block feature information matches the first block feature information and that is in the at least one pixel block.

16. The UAV according to claim 14, wherein for the determining a first pixel block in the first image and a second pixel block that matches the first pixel block and that is in the second image, the processor is specifically configured to:
determine the first pixel block in the first image;
determine at least one pixel block in the second image;
perform pixel matching on the first pixel block and the at least one pixel block; and
determine a second pixel block in the at least one pixel block according to a matching result obtained through the pixel matching.

17. The UAV according to claim 16, wherein for the determining a second pixel block in the at least one pixel block according to a matching result obtained through the pixel matching, the processor is specifically configured to:
use, as a second pixel block, a pixel block having a highest degree of matching a pixel of the first pixel block in the at least one pixel block.

18. The UAV according to claim 14, wherein for the determining a first pixel block in the first image and a second pixel block that matches the first pixel block and that is in the second image, the processor is specifically configured to:
determine a first pixel point in the first pixel block in the first image;
determine at least one pixel block in the second image;
match the first pixel point with a pixel point comprised in each of the at least one pixel block; and
use, as a second pixel block, a pixel block that comprises a pixel point matching the first pixel point and that is in the at least one pixel block.

19. The UAV according to claim 18, wherein for the matching the first pixel point with a pixel point comprised in each of the at least one pixel block, the processor is specifically configured to:
determine point feature information of the first pixel point;
determine point feature information of the pixel point comprised in each of the pixel blocks; and
match point feature information of the first pixel point with point feature information of the pixel point comprised in each of the pixel blocks.

20. The UAV according to claim 14, wherein the processor is further configured to:
determine first location information of the first pixel block and second location information of the second pixel block; and
determine a parallax value of the first pixel block and the second pixel block according to the first location information and the second location information.
